(19) United States
(12) Patent Application Publication
(10) Pub. No.: US 2017/0224155 A1
(43) Pub. Date: Aug. 10, 2017

(54) FEEDING DEVICE AND BAKING APPARATUS INCLUDING THE SAME

(71) Applicant: Tsann Kuen (Zhangzhou) Enterprise Co., Ltd., Zhangzhou (CN)

(72) Inventors: Chungho Pan, Zhangzhou (CN); Jiawei Li, Zhangzhou (CN)

(73) Assignee: Tsann Kuen (Zhangzhou) Enterprise Co., Ltd., Zhangzhou (CN)

(21) Appl. No.: 15/416,285

(22) Filed: Jan. 26, 2017

(30) Foreign Application Priority Data
Feb. 5, 2016 (CN) 201610082022.6

(51) Int. Cl. A47J 37/01

(52) U.S. Cl. CPC A47J 37/01

(57) ABSTRACT

A feeding device is to be mounted on a baking apparatus and includes a container and a conveying unit. The container is formed with a containing space for containing food material and includes an outlet spaced apart from the containing space. The conveying unit is disposed between the containing space and the outlet, and is configured to convey the food material from the containing space to the outlet for dispensing the food material from the outlet to the baking apparatus.

### CROSS-REFERENCE TO RELATED APPLICATION

This application claims priority of Chinese Patent Application No. 201610082022.6, filed on Feb. 5, 2016.

### FIELD

The disclosure relates to a baking apparatus for heating food material, and a feeding device of the baking apparatus.

### BACKGROUND

A conventional baking apparatus includes a heating plate for heating a food material (e.g., for making eatables such as a pancake). In use, the food material is placed manually onto the heating plate in order to be heated.

However, in cases where a plurality of servings of food material are to be baked (e.g., to make a plurality of pancakes), repeated placing actions must be performed, which may be inconvenient for a user operating the baking apparatus. Moreover, it is relatively difficult for a user to provide the same amount of the food material in each of the placing actions.

### SUMMARY

Therefore, an object of the disclosure is to provide a feeding device and a baking apparatus including the same that can alleviate at least one of the drawbacks of the prior art.

According to one aspect of the disclosure, the feeding device to be mounted on a baking apparatus includes a container and a conveying unit. The container is formed with a containing space for containing food material and includes an outlet spaced apart from the containing space. The conveying unit is disposed between the containing space and the outlet, and is configured to convey the food material from the containing space to the outlet for dispensing the food material from the outlet to the baking apparatus.

According to another aspect of the disclosure, the baking apparatus includes the feeding device and a baking device. The feeding device includes a container and a conveying unit. The container is formed with a containing space for containing food material and includes an outlet spaced apart from the containing space. The conveying unit is disposed between the containing space and the outlet, and is configured to convey the food material from the containing space to the outlet for dispensing the food material. The baking device includes a baking plate and a baking unit. The baking plate is disposed relative to the outlet for receiving the food material dispensed by the feeding device. The baking unit is disposed adjacent to the baking plate to heat the baking plate for baking the food material received on the baking plate.

### BRIEF DESCRIPTION OF THE DRAWINGS

Other features and advantages of the disclosure will become apparent in the following detailed description of the embodiments with reference to the accompanying drawings, of which:

FIG. 1 is a partly exploded perspective view illustrating a first embodiment of a baking apparatus according to the disclosure;

FIG. 2 is a sectional side view illustrating one embodiment of a feeding device of the baking apparatus according to the disclosure;

FIG. 3 is a fragmentary sectional view illustrating one embodiment of the feeding device of the baking apparatus according to the disclosure;

FIG. 4 is an exploded perspective view illustrating one embodiment of a conveying tube and a conveying component of the baking apparatus;

FIG. 5 is an exploded perspective view illustrating the first embodiment of the baking apparatus according to the disclosure;

FIG. 6 is a sectional side view illustrating one embodiment of a baking device of the baking apparatus according to the disclosure;

FIG. 7 is a schematic top view illustrating baked food material is moved along a path through one embodiment of a separator device and an unloading device of the baking apparatus;

FIG. 8 is a fragmentary sectional top view illustrating one embodiment of the baking device of the baking apparatus;

FIG. 9 is a block diagram illustrating one embodiment of system architecture of the baking apparatus;

FIG. 10 is a flowchart illustrating one embodiment of an operation flow of the baking apparatus;

FIG. 11 is a flowchart illustrating a process flow of an example of baking the food material using the baking apparatus; and

FIG. 12 is an exploded perspective view illustrating one embodiment of the conveying tube and the conveying component of the baking apparatus according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that the directional references, such as “upward”, “downward” and the like, made throughout this disclosure are to be understood as the ordinary directional relationships when looking directly at the figures.

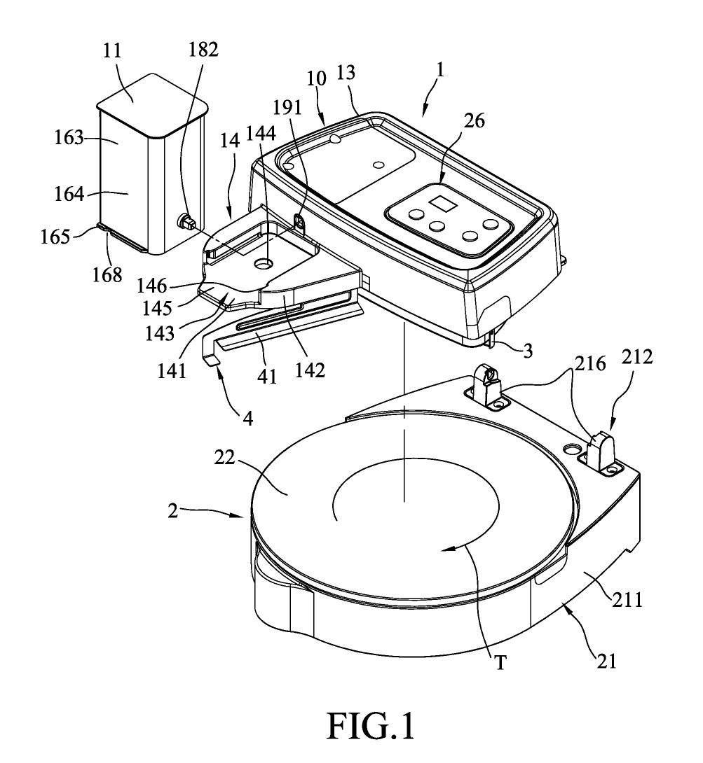

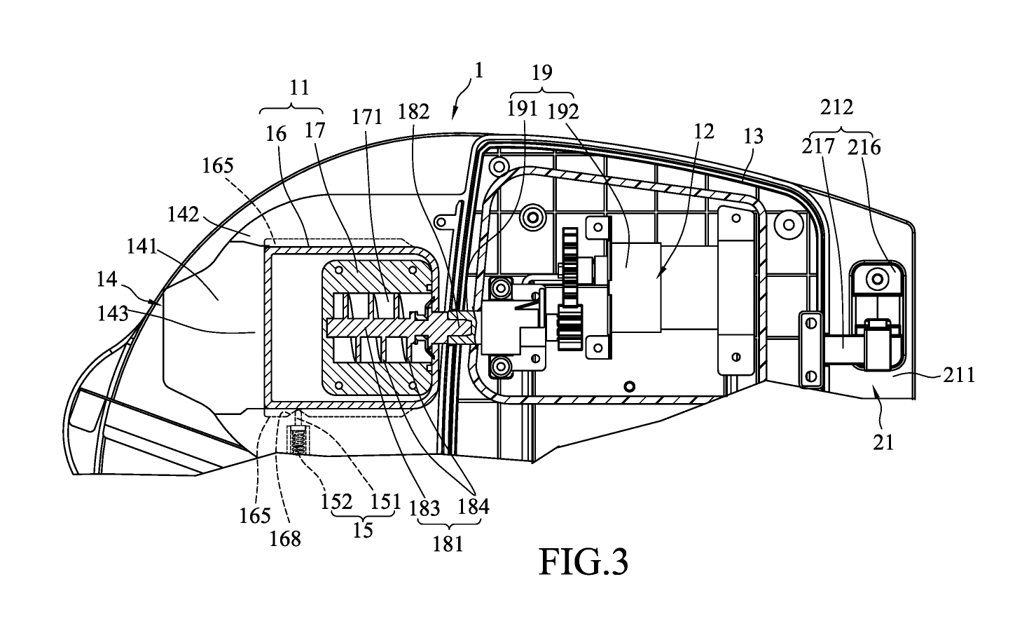

Referring to FIGS. 1 to 3, a first embodiment of a baking apparatus according to the disclosure is illustrated. The baking apparatus is used for baking a food material (e.g., wheat flour, yeast powder, milk, butter, sugar, cocoa solids, water or combinations thereof). The food material may be baked to make eatables such as a pancake, a crumpet, a waffle, etc.

The baking apparatus includes a feeding device 1, a baking device 2, a separator device 3 and an unloading device 4.

The feeding device 1 includes a container 11, an upper base 10 having the container 11 removably mounted thereon, and a conveying unit 12.

The upper base 10 includes a hollow upper base body 13, a holder 14 extending from the upper base body 13, and a fastening mechanism 15 disposed on the holder 14 for fastening the container 11 on the holder 14.

The holder 14 defines a holding space 143 for removable placement of the container 11. The holder 14 includes a holder bottom wall 141, and a holder surrounding wall 142 extending upward from the holder bottom wall 141. The holder bottom wall 141 and the holder surrounding wall 142 cooperate to define the holding space 143. The holder bottom wall 141 is formed with a feeding opening 144 that is formed through the holder bottom wall 141 and that is located below the container 11 when the container 11 is placed in the holding space 143. The holder surrounding wall 142 does not completely enclose the holding space 143 such that an open terminal 145 is formed to be in spatial communication with the holding space 143 for allowing horizontal entrance of the container 11 into the holding space 143. The holder surrounding wall 142 is formed with a first coupling portion 146 which is exemplified as two groove portions extending respectively from opposite sides of the open terminal 145, along opposite inner surfaces of the holder surrounding wall 142 toward the upper base body 13. By virtue of the first coupling portion 146, the holding space 143 is wider at the bottom than at the top so that a vertical section of the holding space 143 resembles an inverted T-shape.

The fastening mechanism 15 includes a fastening component 151 and a spring component 152. The fastening component 151 is movably disposed between the holder 14 and the container 11, and protrudes from one of the two groove portions toward the container 11 when the container 11 is placed in the holding space 143. The spring component 152 is disposed between the holder 14 and the fastening component 151, and is configured to provide a restoration force to the fastening component 151 for urging the fastening component 151 to abut against the container 11.

The container 11 includes a container body 16 and a conveying tube 17.

The container body 16 includes a container bottom wall 161, an upper container surrounding wall 163, a lower container surrounding wall 164 and a second coupling portion 165.

The container bottom wall 161 and the upper container surrounding wall 163 cooperate to define a containing space 166 for containing the food material. The container bottom wall 161 and the lower container surrounding wall 164 cooperate to define an installation space 167 for accommodating the conveying tube 17. The container bottom wall 161 separates the containing space 166 and the conveying tube 17. The container bottom wall 161 is formed with a through hole 162 that is in spatial communication with the containing space 166 for passage of the food material out of the containing space 166 therethrough. The container bottom wall 161 extends obliquely in a downward direction from a junction between the upper and lower container surrounding walls 163, 164 toward the through hole 162 so as to enable the food material in the containing space 166 to flow to the through hole 162 by gravity. The upper container surrounding wall 163 surrounds and extends upward from an edge of the container bottom wall 161. The lower container surrounding wall 164 extends from the edge of the container bottom wall 161 and away from the containing space 166 (i.e., downward according to the drawings). The second coupling portion 165 is formed on and protrudes outward from the lower container surrounding wall 164, corresponds to the first coupling portion 146 for removable engagement with the first coupling portion 146, and is formed with a notch 168 for engagement of the fastening component 151 of the fastening mechanism 15 thereinto. Specifically speaking, the second coupling portion 165 includes two connecting walls for engagement with the two groove portions (i.e., the first coupling portion 146) formed on the holder surrounding wall 142. The notch 168 is formed in one of the two connecting walls. By engaging the connecting walls with the groove portions 146 and by engaging the fastening component 151 with the notch 168, the container 11 is stably fastened to the holder 14.

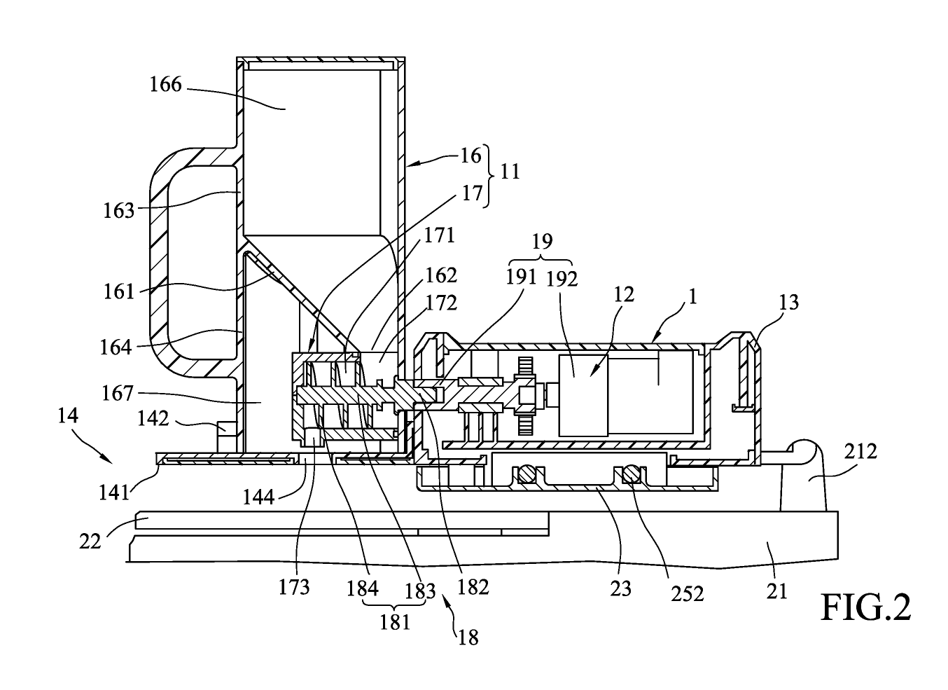

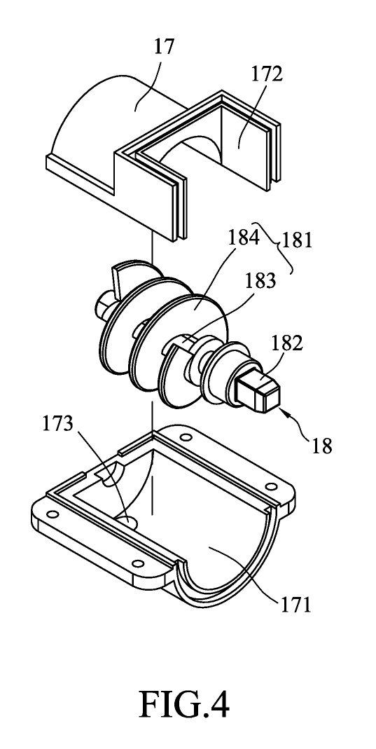

Referring to FIGS. 2-4, the conveying tube 17 is mounted to a portion (i.e., the container bottom wall 161 and the lower container surrounding wall 164) of the container body 16 opposite to the containing space 166. The conveying tube 17 is formed with an outlet 173 spaced apart from the containing space 166, and defines a conveying channel 171 spatially communicating with the containing space 166 and the outlet 173. The outlet 173 corresponds in position to the feeding opening 144 of the holder 14 when the container 11 is placed in the holding space 143. The conveying tube 17 is further formed with an inlet 172 that is in spatial communication with the conveying channel 171 and that is aligned with the through hole 162 for allowing passage of the food material via the through hole 162 and the inlet 172 into the conveying channel 171. The inlet 172 is spaced apart from the outlet 173 and the two are not aligned with each other.

The conveying unit 12 is disposed between the containing space 166 and the outlet 173, and is configured to convey the food material from the containing space 166 to the outlet 173 for dispensing the food material. The conveying unit 12 includes a conveying component 18 and a conveyance driving module 19. The conveying component 18 is rotatable about a first axis and is mounted to the conveying tube 17. The conveyance driving module 19 is configured for driving rotation of the conveying component 18. The food material in the conveying channel 171 is conveyed to the outlet 173 when the conveying component 18 is driven to rotate.

The conveying component 18 includes a conveying body 181 and an engaging part 182. The conveying body 181 is disposed in the conveying channel 171. The conveying body 181 includes a blade shaft 183 and a blade member 184. The blade shaft 183 extends along the first axis. The blade member 184 is disposed on the blade shaft 183. In this embodiment, the blade member 184 is a spiral blade disposed along the blade shaft 183, but is not limited thereto. Blades on the spiral blade are spaced apart from each other by an equal distance. The blade shaft 183 and the blade member 184 of the conveying component 18 are disposed in the conveying channel 171 so as to convey the food material from the containing space 166 via the conveying channel 171 to the outlet 173. The engaging part 182 extends from an end of the conveying body 181 and through the lower container surrounding wall 164 of the container body 16.

The conveyance driving module 19 is mounted to the upper base body 13 of the upper base 10 and is removably engaged to the engaging part 182 of the conveying component 18 so as to rotate the conveying component 18. Specifically, the conveyance driving module 19 includes an exposed engaging head 191 that extends through the upper base body 13 for engagement with the engaging part 182, and a motor 192 for driving rotation of the engaging head 191. In this embodiment, the engaging part 182 is implemented by a prismatic block, such as a rectangular prism, and the engaging head 191 is formed with a square slot so as to be non-rotatably engaged with the engaging part 182. However, implementation may vary in other embodiments as long as the engaging head 191 and the engaging part 182 non-rotatably engage. For example, the engaging part 182 is implemented by a triangular prism or an elliptical cylinder, and the engaging head 191 may be formed with a triangular slot or an elliptical slot, respectively. Moreover, it is feasible that the engaging head 191 is implemented by the prismatic block, and the engaging part 182 is formed with the square slot. Implementation of the engagement therebetween is not limited to the disclosure herein.

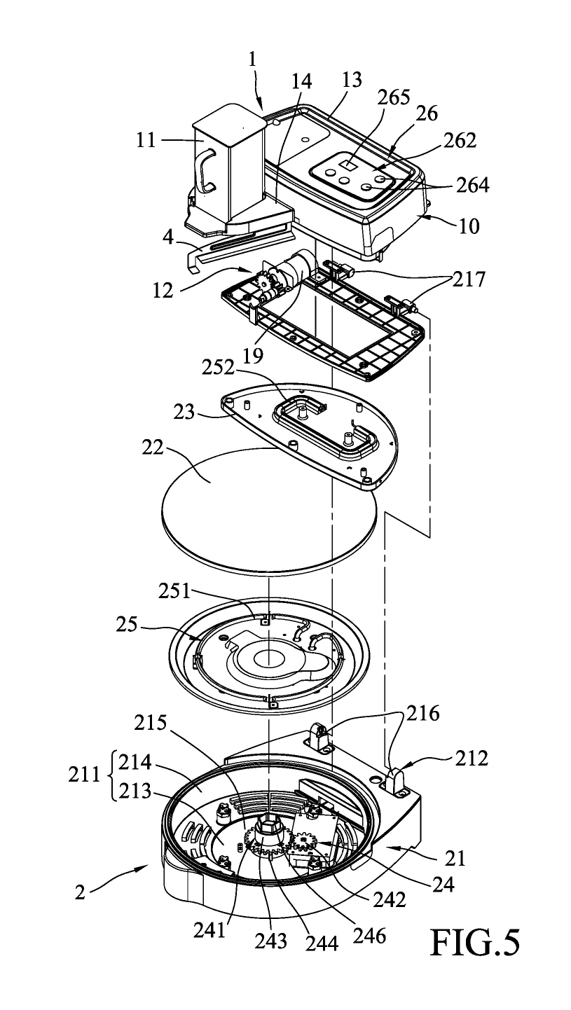

Referring to FIGS. 5-7, the baking device 2 includes a lower base 21, a first baking plate 22 mounted to the lower base 21, a second baking plate 23 mounted to a bottom of the upper base 10, a rotation unit 24 configured to rotate the first baking plate 22 about a second axis for bringing the food material received on the first baking plate 22 to move along a path (T) for baking, a baking unit 25 and a control unit 26 that is communicably connected with the conveying unit 12, the rotation unit 24 and the baking unit 25.

The lower base 21 includes a lower base body 211 and a pivot mechanism 212 for pivotally and removably connecting the upper base body 13 to the lower base body 211. The lower base body 211 includes a housing bottom wall 213 that can be stably placed on a plane, and a housing surrounding wall 214 that extends upward from a peripheral of the housing bottom wall 213. The housing bottom wall 213 and the housing surrounding wall 214 cooperate to define a bottom space 215.

In this embodiment, the pivot mechanism 212 is embodied using a pair of lugs 216 that extend upward from a rear side of the housing surrounding wall 214 and that are spaced apart from each other, and two pivot rods 217 that are connected to a rear side of the upper base body 13 and that pivotally engage the lugs 216, respectively. The pivot rods 217 are rotatable about a third axis, such that the upper base 10 is hinged to the lower base 21 for allowing movement between an opening position (not shown) and a closed position (FIG. 2). It is worth to note that various embodiments may be employed to implement the pivot mechanism 212 in order to achieve a similar result.

The first baking plate 22 is substantially circular in shape and is disposed relative to the outlet 173 for receiving the food material dispensed by the feeding device 1. The first baking plate 22 is made of a thermal conductive material such as iron so as to be heated by the baking unit 25. The first baking plate 22 is formed with a first engaging portion 221 at a center of a bottom thereof. A portion of the first baking plate 22 cooperates with the holder 14 to define a feeding space 222 therebetween for accommodating one serving of the food material. The path (T) starts from the feeding space 222.

The second baking plate 23 is substantially semicircular in shape. The second baking plate 23 is disposed above the first baking plate 22 and is spaced apart from the first baking plate 22. The second baking plate 23 is made of a thermal conductive material such as iron so as to be heated by the baking unit 25. Another portion of the first baking plate 22 cooperates with the second baking plate 23 to define a baking space 223 therebetween for baking two servings of the food material. The baking space 223 is located downstream relative to the feeding space 222 along the path (T).

Referring to FIGS. 5, 6 and 8, the rotation unit 24 includes a rotating shaft 241 rotatably mounted to the housing bottom wall 213, and a rotation driving module 242 for driving rotation of the rotating shaft 241.

The rotating shaft 241 is coupled to the first baking plate 22, and includes a shaft body 243 extending upward, four protruding components 244, a passive gear 245 surrounding a peripheral of the shaft body 243, and a second engaging portion 246 disposed at a top of the shaft body 243 for being removably connected to the first engaging portion 221. Driven by the rotation driving module 242, the shaft body 243 is rotatable about the second axis which passes through the shaft body 243. The protruding components 244 extend radially from the shaft body 243 and are evenly spaced apart from each other by an angle. In this embodiment, the second engaging portion 246 is a hexagonal block protruding upward, and the first engaging portion 221 is formed with a hexagonal recess such that the first and second engaging portions 221 and 246 are engaged non-rotatably to each other. It should be noted that implementations of the first and second engaging portions 221 and 246 may vary in other embodiments as long as the first and second engaging portions 221 and 246 are engaged non-rotatably to each other. For example, the first and second engaging portions 221 and 246 may be in other shapes, and are not limited to that of this embodiment.

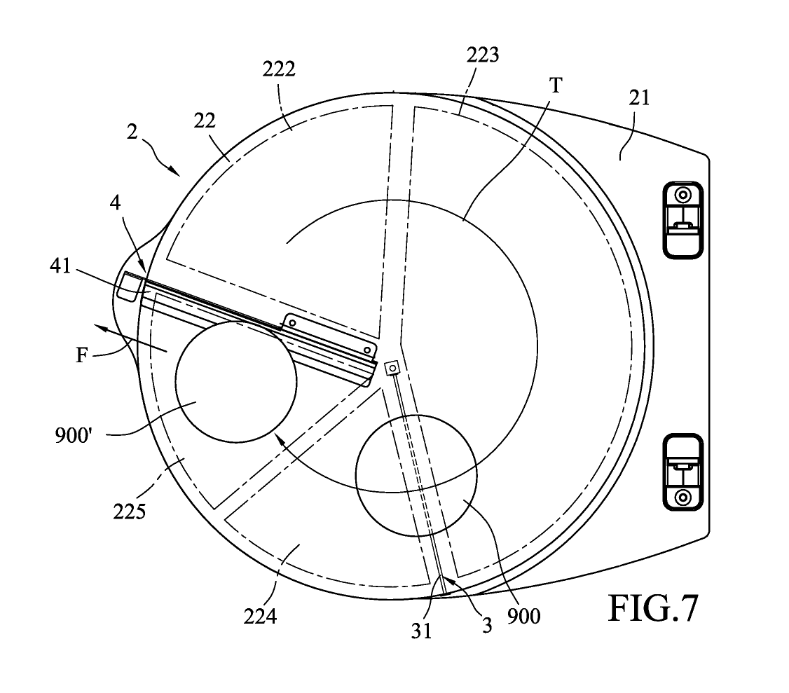

The rotation driving module 242 is configured to drive rotation of the rotating shaft 243 about the second axis. The rotation driving module 242 includes an active gear 247 engaging the passive gear 245, and a motor 248 for driving rotation of the active gear 247. In this embodiment, a number of teeth on the passive gear 245 is larger than that on the active gear 247 so as to magnify torque delivered to the rotating shaft 243, but implementations of the numbers of teeth on the active and passive gears 247 and 245 are not limited thereto. Driven by the rotation driving module 242 to rotate, the rotating shaft 243 brings the first baking plate 22 to rotate such that the food material 900 received on the first baking plate 22 is moved along the path (T) as shown in FIG. 7.

The baking unit 25 includes a first heating module 251 disposed adjacent to the first baking plate 22 for heating the first baking plate 22 so as to bake the food material received on the first baking plate 22, and a second heating module 252 disposed adjacent to the second baking plate 23 for heating the second baking plate 23. The first heating module 251 heats the first baking plate 22 by employing an electrical heating tube mounted to the lower base 21 and arranged correspondingly below the lower baking plate 22. When powered by electricity, the electrical heating tube is capable of generating heat for heating the lower baking plate 22. Similarly, the second heating module 252 heats the second baking plate 23 by employing another electrical heating tube mounted to the upper base 10 and arranged correspondingly above the upper baking plate 23. When powered by electricity, the another electrical heating tube is capable of generating heat for heating the upper baking plate 23.

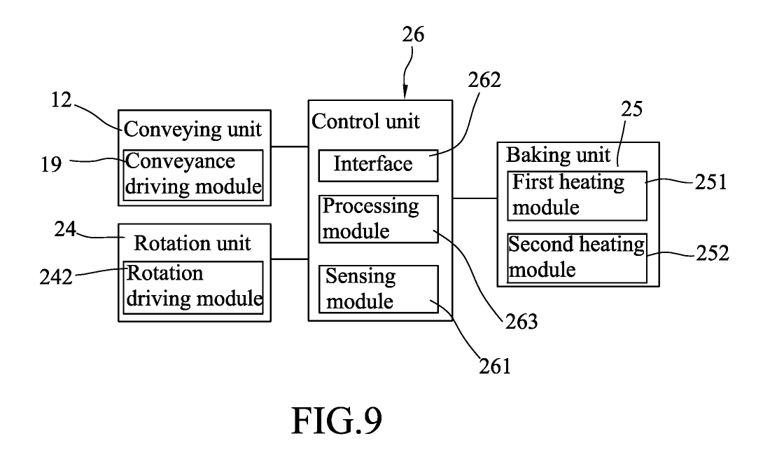

Referring to FIGS. 5, 8 and 9, the control unit 26 includes a sensing module 261, an interface 262 and a processing module 263.

The sensing module 261 is mounted to the lower base body 211, and is spaced apart from the shaft body 243. The sensing module 261 is triggerable, when the rotating shaft 241 is rotating, by the protruding components 244, alternately. In this embodiment, the sensing module 261 is implemented by a mechanical micro switch that is triggered when being contacted. It is worth noting that implementation of the sensing module 261 may vary in other embodiments, and is not limited to this embodiment. For example, the sensing module 261 may be implemented by an infrared trigger for sensing an angle of rotation of the rotating shaft 241.

The interface 262 includes a display screen 265 and a button set 264 which are disposed on the upper base body 13. The interface 262 allows user input of a number of baking operations (i.e., the number of servings of the food material to be baked), a feeding time period during which the food material is to be fed from the containing space 166 to the baking device 2 (i.e., to control the amount of food material dispensed), and a baking time period during which the food material is to be baked in the baking space 223. In other embodiments, the interface 262 may be embodied using a touch screen, and is not limited to this embodiment. Moreover, in other embodiments, the control unit 26 may be configured to determine the feeding time period, to control the conveying unit 12 to convey the food material from the containing space 166 during the feeding time period, and to stop the conveying unit 12 from conveying the food material from the containing space 166 when the feeding time period has elapsed.

The processing module 263 is communicably connected with the sensing module 261, the interface 262, the conveyance driving module 19, the rotation driving module 242, the first heating module 251 and the second heating module 252. The processing module 263 is configured to control the rotation driving module 242 to drive rotation of the rotating shaft 241, and to stop the rotation driving module 242 from driving rotation of the rotating shaft 241 when rotation of the rotating shaft 241 brings one of the protruding components 244 to trigger the sensing module 261. The processing module 263 controls the conveyance driving module 19 and the rotation driving module 242 according to the feeding and baking time periods inputted.

The operation of the baking apparatus will now be described.

Referring to FIGS. 2, 3 and 9, when it is desired to bake the food material contained in the container 11, a user may operate the interface 262 to activate the baking apparatus for performing a feeding process. In response, the processing module 263 activates the conveyance driving module 19 for driving the conveying component 18 to rotate. When the conveying component 18 is rotating, the food material in the containing space 166 is conveyed from the containing space 166 through the conveying channel 171 and the outlet 173 to the feeding opening 144 for dispensing the food material on the feeding space 222 of the first baking plate 22. Meanwhile, the processing module 263 counts down the feeding time period which is set in advance by the user using the interface 262. After the feeding time period has elapsed, the processing module 263 stops the conveyance driving module 19 so as to stop dispensing the food material in the containing space 166 and to complete the feeding process.

It should be noted that the amount of food material delivered is directly proportional to the feeding time period based on an assumption that a rotational speed of the conveying component 18 is constant. Therefore, by virtue of shape design of the conveying component 18 which is driven to rotate for conveying the food material, it is convenient to standardize the amount of food material to be baked by adjusting the feeding time period.

Referring to FIGS. 5, 8 and 9, the baking apparatus may be controlled to perform a rotating operation.

In the rotating operation, the processing module 263 activates the rotation driving module 242 to drive the rotation of the rotating shaft 241 so as to rotate the first baking plate 22. The rotating first baking plate 22 brings the food material received thereon to move along the path (T) as shown in FIG. 1. In this embodiment, the rotating shaft 241 rotates in a clockwise direction. In response, the first baking plate 22 is driven to co-rotate with the rotating shaft 241.

When one of the protruding components 244 comes into contact with and triggers the sensing module 261 (i.e., the rotating shaft 241 has rotated by 90 degrees), the sensing module 261 enables the processing module 263 to stop the rotation driving module 242. That is, in this embodiment, one rotating operation turns the first baking plate 22 by 90 degrees in the clockwise direction. In other embodiments, the rotating shaft 241 may rotate in a counterclockwise direction based on different arrangement of the feeding device 1 and the baking device 2.

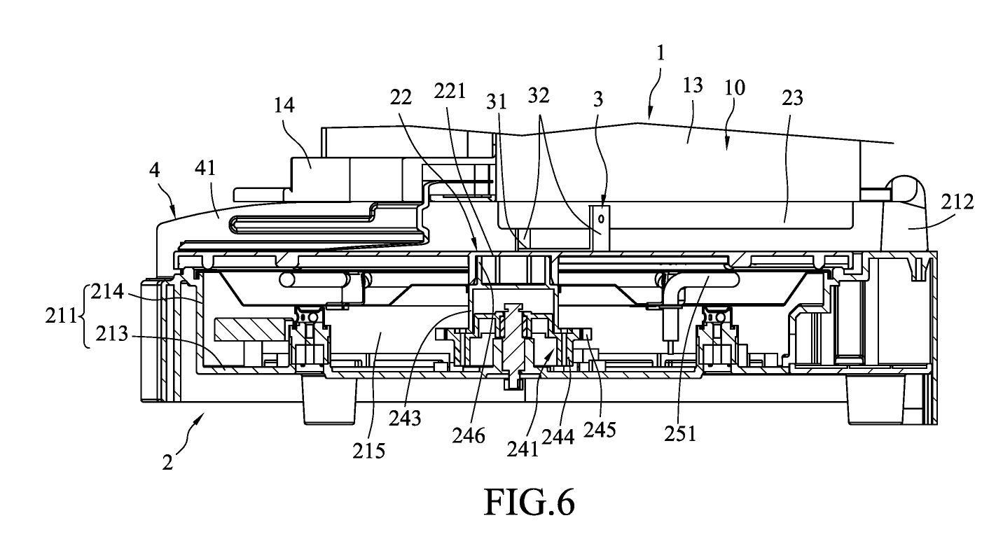

Referring to FIGS. 6 and 7, the separator device 3 is configured to separate the food material thus baked from the first baking plate 22. The separator device 3 includes a separating rod 31 and two connecting components 32 for connecting the separating rod 31 to the upper base 10. The separating rod 31 is disposed in a separating space 224 downstream relative to the baking space 223 along the path (T). The separating rod 31 is configured to abut against a surface of the first baking plate 22 on which the food material is to be disposed, and to extend between a center of the first baking plate 22 and an edge of the first baking plate 22 for allowing the food material thus baked to cross over the separating rod 31 so as to separate the food material thus baked from the first baking plate 22 without adhering to the surface thereof. As shown in FIG. 7, after the food material 900 passes through the baking space 223 along the path (T), the food material 900 is baked to result in the baked food material 900′. When the baked food material 900′ is moved further down the path (T) and enters the separating space 224, the baked food material 900′ crosses over the separating rod 31, and is separated and ready to be removed from the first baking plate 22.

The unloading device 4 is configured to unload the food material thus baked (i.e., the baked food material) from the first baking plate 22. The unloading device 4 includes a blocking wall 41 mounded to the bottom of the upper base 10 and is disposed in an unloading space 225 downstream relative to the separating space 224 along the path (T). The blocking wall 41 is configured to extend between the center of the first baking plate 22 and the edge of the first baking plate 22 for blocking passage of the baked food material so as to unload the baked food material from the first baking plate 22. As shown in FIG. 7, when the baked food material 900′ is moved further downstream along the path (T) and enters the unloading space 225, the baked food material 900′ will be blocked by the blocking wall 41 to be repelled away from the first baking plate 22 in a leaving direction (F).

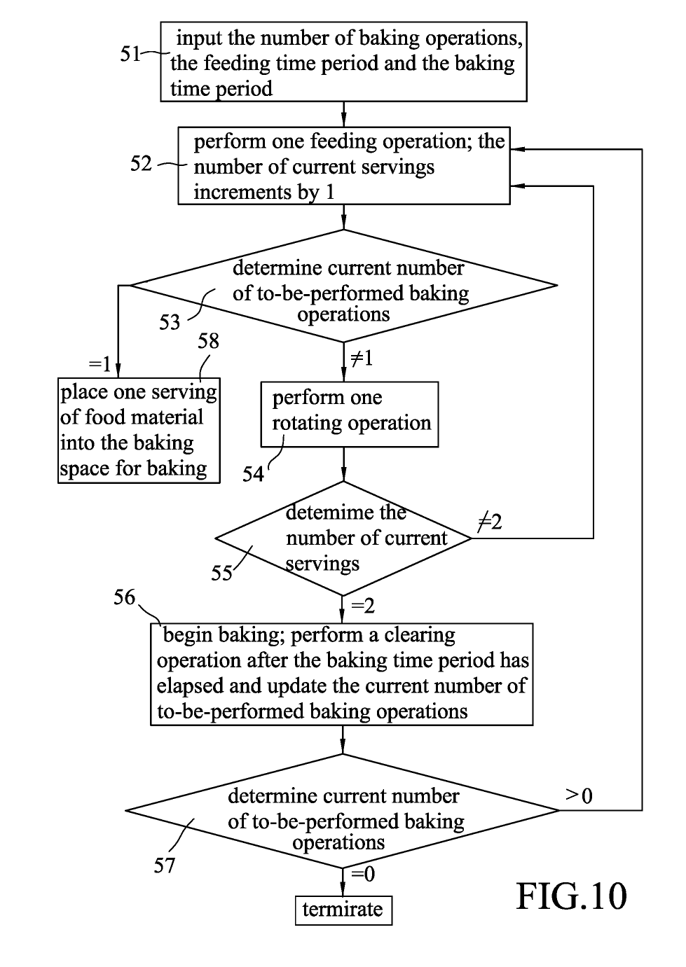

Referring to FIGS. 7, 9, 10 and 11, steps of a method for operating the baking apparatus to bake the food material is illustrated.

In step 51, the user of the baking apparatus inputs the number of baking operations (i.e., the number of servings of the food material to be baked), the feeding time period and the baking time period. In this embodiment, the number of baking operations, the feeding time period and the baking time period are set to be, but not limited to, four, 5 seconds and 150 seconds, respectively. The processing module 263 further stores a number of current servings of the food material on the first baking plate 22, and a current number of to-be-performed baking operations. In the beginning, the number of current servings is 0, and the current number of to-be-performed baking operations equals the number of baking operations inputted by the user through the interface 262, i.e., 4. The number of current servings is increased by 1 after each completion of the feeding process. Moreover, the first heating module 251 and the second heating module 252 are powered on for preheating the first baking plate 22 and the second baking plate 23.

In step 52, after the first baking plate 22 and the second baking plate 23 have reached a temperature adequate for baking the food material, the processing module 263 controls the conveying unit 12 of the baking apparatus to perform one feeding operation.

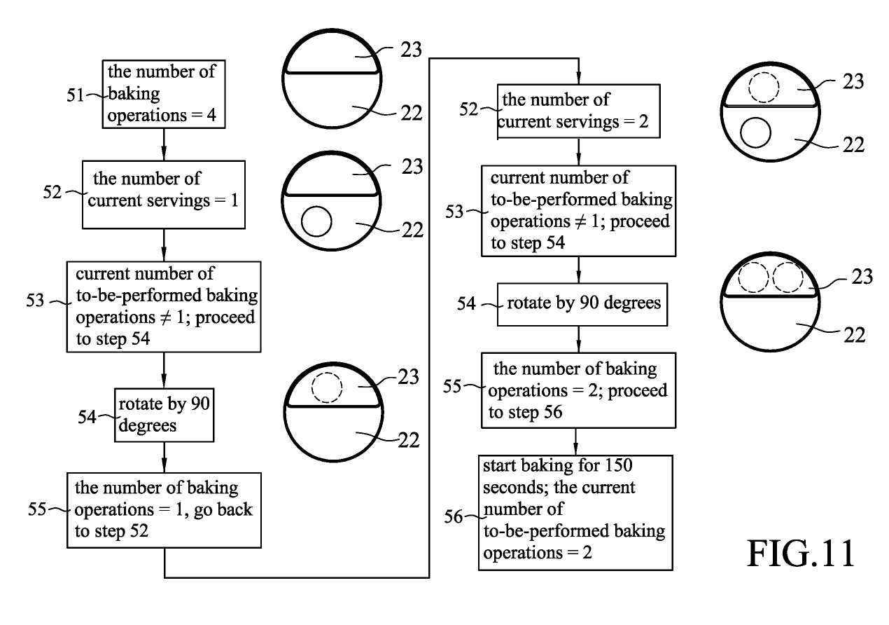

The feeding operation results in one serving of the food material (of 5 seconds worth) being fed into the feeding space 222 of the first baking plate 22, as shown in FIGS. 7 and 11. The number of current servings is increased by 1.

Afterward, in step 53, the processing module 263 determines how many serving(s) of the food material is yet to be baked (i.e., a remaining number of baking operations as indicated by the current number of to-be-performed baking operations). When the number equals 1, the flow proceeds to step 58. Otherwise, the flow proceeds to step 54. In this case, since the current number of to-be-performed baking operations is 4, the flow proceeds to step 54.

In step 54, the processing module 263 controls the rotation unit 24 to perform one rotating operation, in which the first baking plate 22 rotates with respect to the second baking plate 23 by 90 degrees in the clockwise direction. The food material fed onto the first baking plate 22 in step 52 is thus moved under the second baking plate 23 (i.e., from the receiving space 222 to the baking space 223) for baking.

In step 55, the processing module 263 determines how many serving(s) of food material is currently on the first baking plate 22 (i.e., by determining the number of current servings). When it is determined that the number of current servings does not equal to 2, the flow goes back to step 52 for repeating steps 52 to 55 until it is determined that two servings of food material are in the baking space 223 for baking. Afterward, the step proceeds to step 56.

In step 56, the baking of the two servings of food material commences, and the processing module 263 begins timing for determining whether the baking time period has elapsed. After the baking time period has elapsed, the processing module 263 controls the baking device 2 to perform a clearing operation, in which the two servings of (baked) food material are removed from the baking space 223. This may be done by controlling the first baking plate 22 to rotate by 180 degrees such that the two servings of baked food material can be automatically separated and removed through the separator device 3 in the separating space 224 and the unloading device 4 in the unloading space 225. Afterward, the processing module 263 decreases the current number of to-be-performed baking operations by the number of current servings (i.e., changed to 2).

In step 57, the processing module 263 detects the current number of to-be-performed baking operations. In the case that the current number of to-be-performed baking operations is 0, the method is terminated as no more food material needs to be baked. In the case that the current number of to-be-performed baking operations is greater than 0 (for example, 2 in this case), the flow goes back to step 52 to perform more baking operations until the current number of to-be-performed baking operations becomes 0, and the processing module 263 resets the number of current servings to zero.

In another example, when the current number of to-be-performed baking operations detected in step 57 is 1, the flow proceeds to step 52 for performing one feeding operation. As described above, the flow proceeds to step 53, and subsequently proceeds to step 58.

In step 58, the processing module 263 controls the rotation unit 24 to perform two rotating operations, so the first baking plate 22 is rotated by 180 degrees for placing the one serving of the food material into the baking space 223. Afterward, the processing module 263 waits for the baking time period to elapse in order to allow the baking apparatus to produce the baked food material, and the method then terminates.

Consequently, by the baking apparatus of this disclosure, the food material can be automatically fed, moved, baked, separated and unloaded. It is worth to note that implementation of the operation is not limited to what has been described above.

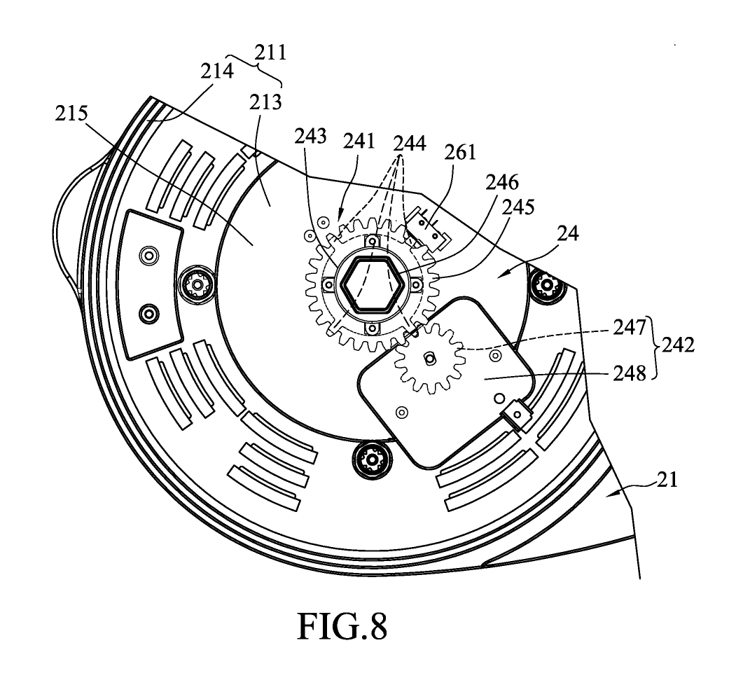

Additionally, referring to FIG. 8, it should be noted that the number of the protruding components 244 is not limited to four. For example, in other embodiments, the number of the protruding components 244 may be six, such that the sensing module 261 is triggered by one of the protruding components 244 every time the rotating shaft rotates by 60 degrees.

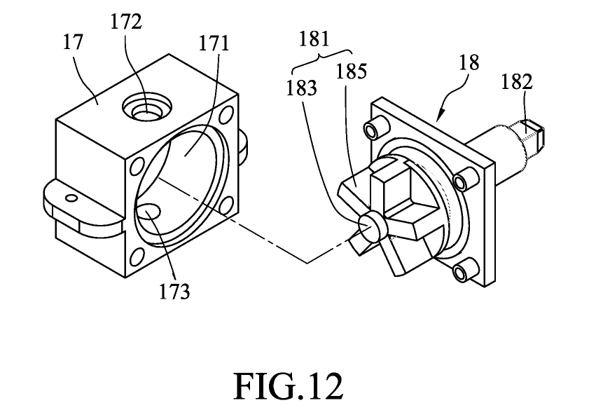

Referring to FIG. 12, the conveying tube 17 and the conveying component 18 of a second embodiment of the baking apparatus according to this disclosure which differ from those of the first embodiment are illustrated. In this embodiment, the inlet 172 and the outlet 173 of the conveying tube 17 are vertically aligned. The conveying body 181 of the conveying component 18 includes the blade shaft 183 extending along the first axis, and the blade member 185. The blade member 185 includes a plurality of blades that are evenly spaced apart from each other by the same angle and that surround the blade shaft 183. The food material in the containing space 166 (see FIG. 2) is conveyed from the inlet 172 through a space defined by adjacent two of the blades to the outlet 173 for dispensing the food material.

To sum up, the baking apparatus as disclosed by the disclosure employs the feeding device 1 and the baking device 2 in order to automatically dispense servings of the food material of the same amount according to the feeding time period, and to control the food material to be baked accurately for the baking time period. Additionally, the first baking plate 22 is made in a round shape, such that the rotation thereof occupies less space (e.g., relative to plates of other shapes).

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A feeding device to be mounted on a baking apparatus and comprising:
a container formed with a containing space for containing food material and including an outlet spaced apart from the containing space; and
a conveying unit disposed between said containing space and said outlet, and configured to convey the food material from said containing space to said outlet for dispensing the food material from said outlet to the baking apparatus.

2. The feeding device as claimed in claim 1, wherein said conveying unit includes:
a conveying component that is rotatable about an axis and that includes
a blade shaft extending along the axis, and
a blade member disposed on said blade shaft; and
a conveyance driving module for driving rotation of said conveying component.

3. The feeding device as claimed in claim 2, wherein:
said container includes
a container body defining said containing space, and
a conveying tube mounted to a portion of said container body opposite to said containing space, and defining a conveying channel that spatially communicates with said containing space and said outlet formed on said conveying tube, wherein said blade shaft and a spiral blade, which serves as said blade member, of said conveying component are disposed in said conveying channel so as to convey the food material from said containing space via said conveying channel to said outlet.

4. The feeding device as claimed in claim 3, further comprising:
an upper base having said container removably mounted thereon;
wherein said conveying component includes
a conveying body disposed in said conveying channel and including said blade shaft and said spiral blade, and
an engaging part extending from an end of said conveying body and through said container; and
wherein said conveyance driving module is mounted to said upper base and is removably engaged to said engaging part of said conveying component so as to rotate said conveying component.

5. The feeding device as claimed in claim 4, wherein said upper base includes:
a holder defining a holding space for removable placement of said container; and
a fastening mechanism disposed on said holder for fastening said container on said holder, said fastening mechanism including
a fastening component that is movably disposed between said holder and said container, and
a spring component that is disposed between said holder and said fastening component, and that is configured to provide a restoration force to said fastening component for urging said fastening component to abut against said container.

6. The feeding device as claimed in claim 5, wherein:
said holder includes a first coupling portion; and
said container body includes
a container bottom wall separating said containing space and said conveying tube,
a lower container surrounding wall extending from an edge of said container bottom wall and away from said containing space, and
a second coupling portion that is formed on said lower container surrounding wall, that corresponds to said first coupling portion for removable engagement with said first coupling portion, and that is formed with a notch for engagement of said fastening component of said fastening mechanism thereinto.

7. The feeding device as claimed in claim 3, wherein:
said container body is formed with a through hole that is in spatial communication with said containing space for passage of the food material out of said containing space therethrough;
said conveying tube is further formed with an inlet that is in spatial communication with said conveying channel and that is aligned with said through hole for allowing passage of the food material via said through hole and said inlet into said conveying channel, the food material in the conveying channel being conveyed to said outlet when said conveying component is driven to rotate.

8. The feeding device as claimed in claim 2, wherein said blade member is a spiral blade disposed along said blade shaft.

9. The feeding device as claimed in claim 2, wherein said blade member includes:
a plurality of blades that are evenly spaced apart from each other and that surround said blade shaft.

10. A baking apparatus comprising:
a feeding device including
a container formed with a containing space for containing food material and including an outlet spaced apart from the containing space; and
a conveying unit disposed between said containing space and said outlet, and configured to convey the food material from said containing space to said outlet for dispensing the food material;
a baking device including
a first baking plate disposed relative to said outlet for receiving the food material dispensed by said feeding device, and
a baking unit disposed adjacent to said first baking plate to heat said first baking plate for baking the food material received on said first baking plate.

11. The baking apparatus as claimed in claim 10, wherein said baking device further includes a rotation unit configured to rotate said first baking plate about an axis for bringing the food material received on said first baking plate to move along a path for baking.

12. The baking apparatus as claimed in claim 11, wherein:
said rotation unit includes
a rotating shaft that is coupled to said first baking plate, and that includes
a shaft body rotatable about the axis which passes through said shaft body, and
a plurality of protruding components extending radially from said shaft body and being evenly spaced apart from each other by an angle, and
a rotation driving module configured to drive rotation of said rotating shaft about the axis; and
said baking device further includes
a control unit that is communicably connected with said rotation unit, and that includes
a sensing module spaced apart from said shaft body, and triggerable by said plurality of protruding components, alternately, and
a processing module communicably connected with said sensing module and said rotation driving module, and configured to control said rotation driving module to drive rotation of said rotating shaft, and to stop said rotation driving module from driving rotation of said rotating shaft when rotation of said rotating shaft brings one of said plurality of protruding components to trigger said sensing module.

13. The baking apparatus as claimed in claim 10, wherein said baking device further includes a control unit that is communicably connected with said conveying unit, and that is configured to determine a feeding time period, to control said conveying unit to convey the food material from said containing space during the feeding time period, and to stop said conveying unit from conveying the food material from said containing space when the feeding time period has elapsed.

14. The baking apparatus as claimed in claim 10, wherein:
said baking device further includes a second baking plate disposed above said first baking plate and spaced apart from said first baking plate, a portion of said first baking plate and said second baking plate cooperating to define a baking space therebetween for baking the food material; and
said baking unit includes
a first heating module for heating said first baking plate, and
a second heating module for heating said second baking plate.

15. The baking apparatus as claimed in claim 10, further comprising a separator device that is configured to separate the food material thus baked from said first baking plate, and that includes
a separating rod configured to abut against a surface of said first baking plate on which the food material is to be disposed, and to extend between a center of said first baking plate and an edge of said first baking plate for allowing the food material thus baked to cross above said separating rod so as to separate the food material thus baked from said first baking plate.

16. The baking apparatus as claimed in claim 10, further comprising an unloading device that is configured to unload the food material thus baked from said first baking plate, and that includes
a blocking wall configured to extend between a center of said first baking plate and an edge of said first baking plate for blocking passage of the baked food material so as to unload the food material thus baked from said first baking plate.
